(19) United States
(12) Patent Application Publication
(10) Pub. No.: US 2016/0186493 A1
(43) Pub. Date: Jun. 30, 2016

(54) Hunting ladder guard

(71) Applicant: Tony R. Young, Mount Juliet, TN (US)

(72) Inventor: Tony R. Young, Mount Juliet, TN (US)

(21) Appl. No.: 15/066,744

(22) Filed: Mar. 10, 2016

Related U.S. Application Data
(63) Continuation-in-part of application No. 14/558,533, filed on Dec. 2, 2014.

(51) Int. Cl. E06C 7/00

(52) U.S. Cl. CPC E06C 7/006

(57) ABSTRACT

A ladder guard to prevent access to a hunting ladder, includes: a ladder guard plate, including an inward protruding plate hook, that attaches to a rung of the ladder; at least two bracket apertures; and a bracket with upper and lower legs, each including a padlock aperture, such that the ladder guard attaches with the plate hook to an upper rung of the ladder; and the bracket locks the guard plate to a lower rung, with a padlock. Also disclosed is a ladder guard, including a ladder guard plate, with a plate cutout, ladder guard apertures, and a stabilizer bracket, including a connector plate with connector plate aperture, upper and lower flange portions, upper and lower flange extensions with extension apertures, such that the ladder guard is locked to a ladder using a padlock inserted through the extension apertures.

### CROSS-REFERENCE TO RELATED APPLICATIONS

This application is a continuation-in-part of U.S. Non-Provisional application Ser. No. 14/558,533, filed Dec. 2, 2014.

### FIELD OF THE INVENTION

The present invention relates generally to the field of ladders and devices for ladders. More particularly, the present invention relates to a protective ladder guard for hunting stands to prevent unauthorized persons from ascending the ladder to reach the hunting stand platform in the owner's absence.

### BACKGROUND OF THE INVENTION

The use of ladder hunting stands, which provide an elevated platform above the ground while hunting wild game animals, is well documented. There are numerous commercially available ladder tree stands, tri-pod stands, elevated modular stands, automated game feeder systems and the like, which provide access to an elevated platform or enclosure relative to the ground, using an integral ladder for climbing. While tree stand manufacturers produce a wide variety of ladder stands, they do not provide devices designed to prevent unauthorized persons from climbing the ladder to reach the hunting platform in the owner's absence. Such a device would prevent trespassing, the poaching of wild game animals, and the theft or vandalism of the tree stand or the tree stand accessories. As a result, demand exists for a simple, portable, convenient, inexpensive protective device, designed to prevent unauthorized persons from ascending the ladder to reach a hunting platform above.

The unauthorized climbing of ladder hunting stands is a problem many hunters face. This unwelcome behavior may often result in the theft of the hunting stand, hunting stand accessories or other valuable personal property, and facilitates the poaching of wild game animals. Many tri-pod, elevated modular stands and automated game feeder systems have further refinements of value also posing a risk of theft or vandalism. The aftermath of such trespassing activity continues to be a source of great frustration to honest and ethical hunters.

Ladder guards, which deter unauthorized ladder climbing are well known. U.S. Pat. No. 7,793,759 to Aiken, U.S. Pat. No. 7,717,231 to Horton, U.S. Pat. No. 5,441,126 to Orrick, U.S. Pat. No. 4,126,206 to Becnel, and U.S. Pat. No. 3,968,857 to Bryan are examples representing endeavors to block access to a plurality of rungs to prevent unauthorized climbing of ladders. While such devices and methods suit their intended purpose well for use with commercial ladders, step ladders, swimming pool ladders and the like, or for ladders of a type permanently secured to tall buildings, radio towers, storage tanks and the like, they are not satisfactory for use with modern ladder hunting stands, and do not effectively solve many specific problems faced by hunters.

One solution, the Vital-Security™ slide/lock by Vital Zone™, requires permanent structural modifications be made to the lower bottom two sections from the original tree stand ladder, which incorporate a set of sleeves and hinges now integral to the intersecting ladder columns, locking pin mechanisms and padlocks. In use, both hinge mechanisms are first unlocked and then the protective sleeves are raised to allow the bottom section of the ladder to be folded upward to connect with a receiver housing integral to the next uppermost section of the ladder, allowing the hinge mechanism to be secured using a locking pin, and then be finally secured using a padlock. To lower the ladder section and return it to ground level, the process is reversed, thus allowing access to the ladder.

Another solution, manufactured by Primal Vantage™, requires permanent replacement of the lower bottom section from the original tree stand ladder, with a new section of ladder, having a removable square framed insert having two rungs welded horizontally inside the frame, requiring four long threaded bolts to be passed through the column from the outside and secured into four threaded receiver holes integral to the square framed insert. To prevent climbing the ladder, the four long bolts must be removed and retained for later use, the insert section must be removed, and transported to and from the hunting stand each time. The process is reversed to reinstall the section, thereby allowing access to the ladder.

Many hunters reject such solutions because of the many potential safety problems and mechanical difficulties encountered while attempting to retrofit a ladder hunting stand that has already been installed. In the case of ladder tree stands, the ladder supplied by the manufacturer is an integral component of the product's design, thus any post installation modifications could affect the tree stand's structural integrity. Once connected and installed, each section of the ladder serves to support the next section sequentially supporting the ladder structure and the tree stand platform. Removing a section of the ladder is risky and difficult post installation due to the difficulty of separating the reverse interconnecting sections, and compounded by the total combined weight of downward forces being applied by the mass of the ladder and tree stand platform. Any attempt to remove the ladder or to rotate a section of the ladder out of the way could negate the structural support element designed for the ladder thus affecting platform sturdiness, allowing other ladder sections to separate or allowing the hunting platform itself to shift position on the tree. Undermining the safety and stability of the tree stand platform in this manner could lead to a potentially unsafe or dangerous situation, especially if the ladder or platform becomes loosened or dislodged from the tree while in use. Should an unfortunate accident or injury occur, the hunter also bears risk of liability should an insurance claim ensue. Potential remedies could also be found limited simply because structural modifications were made to the tree stand after purchase.

Another problem encountered is that these solutions require several time consuming, intricate, multi-step tasks, which must be completed with a certain degree of precision, and which must be performed safely every time the hunter enters or leaves the area. In addition, it is highly desirable to occupy the hunting stand well before sunrise and depart the area after sunset, thereby increasing the difficulty in performance of these tasks in darkness, thus reducing the safety margin required to perform such tasks. In addition, maintaining total quiet of the surrounding area is also an essential element for successful game hunting. It is doubtful these tasks can be accomplished consistently, quickly, and safely in the dark, without making unwanted metallic noises, which undoubtedly will disturb the wild game animals in the surrounding area. In the case of tri-pod hunting stands or elevated modular houses, the problem encountered is that attempting to retrofit the ladder is likely not a practical solution, because the entire ladder is typically welded to and centered over a main support beam of the tri-pod frame or modular structure. Thus, the presence and positioning of the support beam prevents structural modifications and interferes with retrofitting activity.

As such, considering the foregoing, it may be appreciated that there continues to be a need for novel and improved devices and methods for preventing access to ladder hunting stands, which solves the aforementioned problems, protects the private property of hunters and prevents poaching of wild game animals.

### SUMMARY OF THE INVENTION

The foregoing needs are met, to a great extent, by the present invention, wherein in aspects of this invention, enhancements are provided to the existing model of ladder guards.

Aspects of the present invention relate to a hunting ladder guard for hunting ladder stands, tri-pod stands, modular hunting stands and the like.

In related aspects, the hunting ladder guard provides a simple yet effective protective ladder guard device to prevent unauthorized persons from ascending the ladder to reach the hunting stand platform in the owner's absence, thereby preventing trespassing, theft, vandalism and poaching of wild game animals.

In related aspects, the hunting ladder guard is designed to secure most hunting ladder stands and tri-pod ladder stand designs.

In an aspect, a hunting ladder guard, can include:
a. a ladder guard plate, further including
   i. a plate hook, which is connected to an upper end of the ladder guard plate; is configured as an inward protruding hook that attaches on to an upper rung of a hunting ladder;
   ii. two or more bracket apertures; and
b. a bracket;
such that a lower end of the ladder guard can be attached to a lower rung, and the bracket inserted through two consecutive bracket apertures, which are positioned such that an upper leg of the bracket reaches behind and over the lower rung, and a lower leg of the bracket reaches behind and under the lower rung, such that a padlock can be inserted through padlock apertures in the upper and lower legs of the bracket, thereby locking the ladder guard plate in place on the hunting ladder.

In another aspect, a ladder guard to prevent access to a ladder, can include:
a. a ladder guard plate, further including:
   i. a plate hook, which can be connected to an upper end of the ladder guard plate, such that the plate hook is configured as an inward protruding hook that attaches to a rung of the ladder; and
   ii. at least one plate aperture;
b. at least one bolt;
c. a stabilizer bracket, further including:
   i. a connector plate, further including:
      at least one connector plate aperture;
   wherein the connector plate can be connected to a lower end of the ladder guard plate with the at least one bolt, which can be bolted in place through the at least one plate aperture and the at least one connector plate aperture;
   ii. an upper flange portion, which is connected to the connector plate;
   iii. a lower flange portion, which is connected to the connector plate; and
   iv. an upper flange extension, further including:
   an upper flange extension aperture;
   wherein the upper flange extension is connected to the upper flange portion; and
   v. a lower flange extension, further comprising:
   a lower flange extension aperture,
   wherein the lower flange extension is connected to the lower flange portion;
wherein the upper end of the ladder guard plate is configured to be attached to an upper rung of the ladder using the plate hook; and
the lower end of the ladder guard plate is configured to be attached to a lower rung of the ladder, such that the upper flange portion is above the lower rung and the lower flange portion is below the lower rung;
such that the upper and lower flange extensions extend behind the lower rung;
such that the stabilizer bracket is configured to allow a padlock to be inserted through the upper flange extension aperture and the lower flange extension aperture, thereby locking the stabilizer bracket in place around the lower rung, and thereby locking the lower end of the ladder guard in place, attached to the lower rung.

In related aspects, the hunting ladder guard can be designed to be inexpensive, lightweight, sturdy, weatherproof, convenient, easy to transport, and easy to use. In further related aspects, it can reduce risk of potential serious injury by not requiring a hunter to retro fit, disassemble or reassemble the ladder stand sections because the ladder or hunting platform is never retracted, replaced or moved, and thus does not undermine the hunting stand structural integrity.

In other related aspects, the hunting ladder guard requires no special tools, or installation or removal of nuts and bolts, and complex repetitive installation and removal tasks are reduced to a minimum.

In other related aspects, the hunting ladder guard allows hunters to quickly and quietly unlock the device with a minimum of effort, while standing on the ground, while working in darkness and without disturbing nearby game animals, place the accessory on the ground while hunting, and quickly, easily and quietly reinstall and secure the device before departing the area. Further, in related aspects, because many hunting stands are often located in extremely remote locations, the hunting ladder guard can provide year round protection, should a hunter decide to leave the hunting stand in place during the off-season as a proactive measure or be used to address potential liability concerns, especially when the hunting stand is located on private property.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a perspective view of a ladder guard installed on a hunting ladder, according to an embodiment of the invention.

FIG. 2 illustrates a perspective view of a ladder guard before installation on a ladder, according to an embodiment of the invention.

FIG. 3 illustrates a rear perspective view of a ladder guard installed on a ladder, according to an embodiment of the invention.

FIG. 4 illustrates a front perspective view of a ladder guard plate, according to an embodiment of the invention.

FIG. 5 illustrates a rear perspective view of a ladder guard plate, according to an embodiment of the invention.

FIG. 6 illustrates a perspective view of a bracket of a ladder guard, according to an embodiment of the invention.

FIG. 7 illustrates a side, partially center-cut view of a section of a hunting ladder guard, according to an embodiment of the invention.

FIG. 8 illustrates a perspective view of a ladder guard, according to an embodiment of the invention.

FIG. 9 illustrates a perspective view of a ladder guard installed on a ladder, according to an embodiment of the invention.

FIG. 10 illustrates a front perspective view of a ladder guard, according to an embodiment of the invention.

FIG. 11 illustrates a rear perspective view of a ladder guard installed on a ladder, according to an embodiment of the invention.

FIG. 12A illustrates a perspective view of a stabilizer bracket of a ladder guard, according to an embodiment of the invention.

FIG. 12B illustrates a perspective view of a stabilizer bracket installed on a ladder guard, according to an embodiment of the invention.

FIG. 13A illustrates a perspective view of a stabilizer bracket installed on a ladder guard, according to an embodiment of the invention.

FIG. 13B illustrates a perspective view of a stabilizer bracket installed on a ladder guard, according to an embodiment of the invention.

FIG. 14 illustrates a perspective view of a stabilizer bracket of a ladder guard, according to an embodiment of the invention.

FIG. 15 illustrates a rear perspective view of a ladder guard installed on a ladder, according to an embodiment of the invention.

FIG. 16 illustrates a rear perspective view of a ladder guard installed on a ladder, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

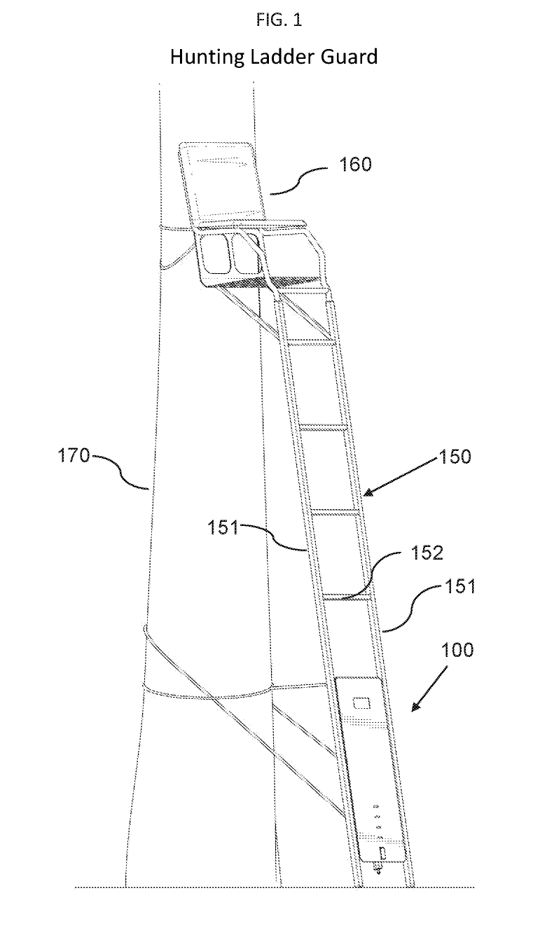

In the following, we describe the structure of an embodiment of a hunting ladder guard 100 with reference to FIG. 1, in such manner that like reference numerals refer to like components throughout; a convention that we shall employ for the remainder of this specification.

In an embodiment, as illustrated in FIG. 1, a hunting ladder guard 100 can be installed on a hunting ladder 150, such that it prevents a person who is not authorized to use the hunting ladder 150 from climbing up the hunting ladder, by covering a plurality of rungs of the ladder 150. FIG. 1 shows the hunting ladder guard 100 installed on a conventional hunting ladder 150, wherein the hunting ladder is installed on a tree 170, with a chair 160 positioned at the end of the hunting ladder 150, such that the chair 160 is resting against and secured to the tree.

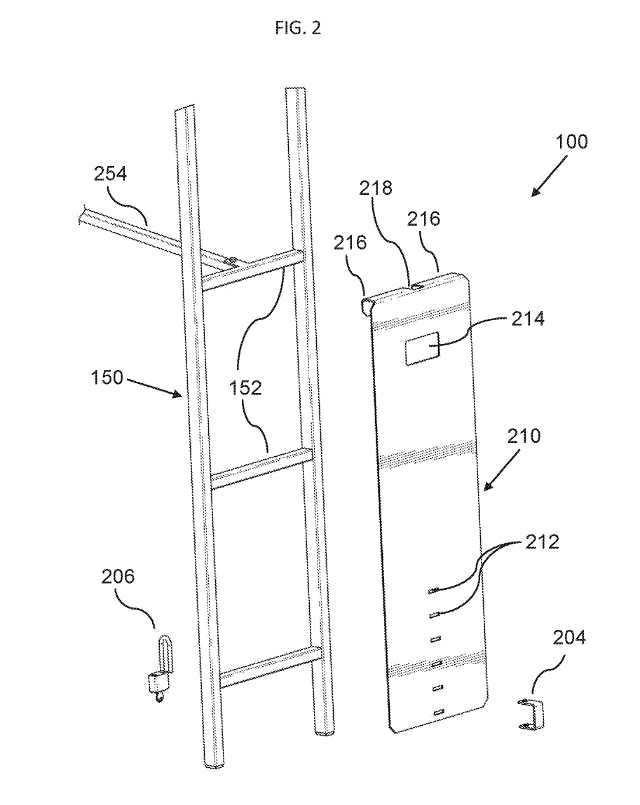

In a related embodiment, as illustrated in FIG. 2, a hunting ladder guard 100, can include:
a) a ladder guard plate 210, further including
   i. a plate hook 216, which is connected to an upper end of the ladder guard plate 210; such that the plate hook 216 is configured as an inward protruding hook that can attach on to a rung 152 of the hunting ladder 150;
   ii. at least two bracket apertures 212; and
b) a bracket 204;
such that the upper end of ladder guard plate can be attached to an upper rung 152 of a ladder 150 using the plate hook 216, and a lower end of the ladder guard 100 can be securely attached to a lower rung 152 of the hunting ladder 150, such that the bracket is inserted through two consecutive bracket apertures 212, which are positioned such that an upper leg of the bracket 204 reaches behind and over the lower rung 152, and a lower leg of the bracket 204 reaches behind and under the lower rung 152, such that a padlock 206 can be inserted through padlock apertures in the upper and lower legs of the bracket 204, thereby locking the bracket in place around the lower rung, and thereby locking the lower end of the hunting ladder guard 100 in place, attached to the lower rung 152.

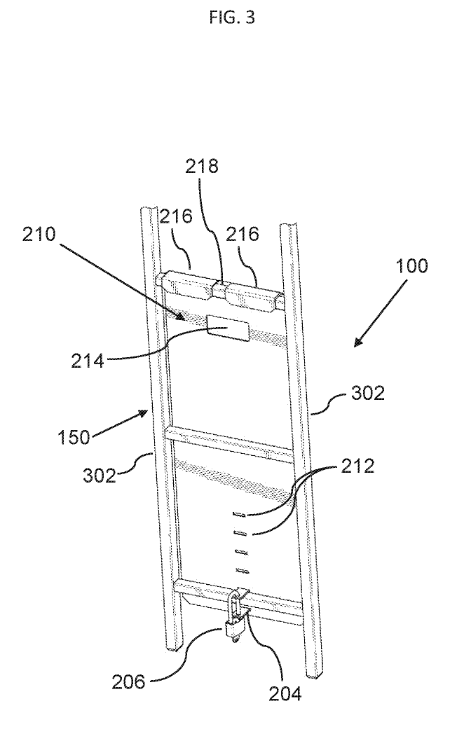

In a related embodiment, FIG. 3 shows a rear view of a hunting ladder guard 100 installed on a ladder 150.

In related embodiments, as shown in FIG. 3, the ladder guard plate 210 when attached to a ladder 150, can be configured to be inside vertical side columns 302 of the ladder such that a gap width between a column 302 and a vertical side of the ladder guard plate 210 is no more than 1-2 inches. A ladder guard plate 210 can thereby fit to ladders of varying width, with some variation of the gap between the vertical sides of the ladder guard plate 210 and the columns 302 of the ladder.

In further related alternative embodiments, a hunting ladder guard 100 can be configured such that a main surface of the ladder guard plate 210 covers the vertical side columns 302.

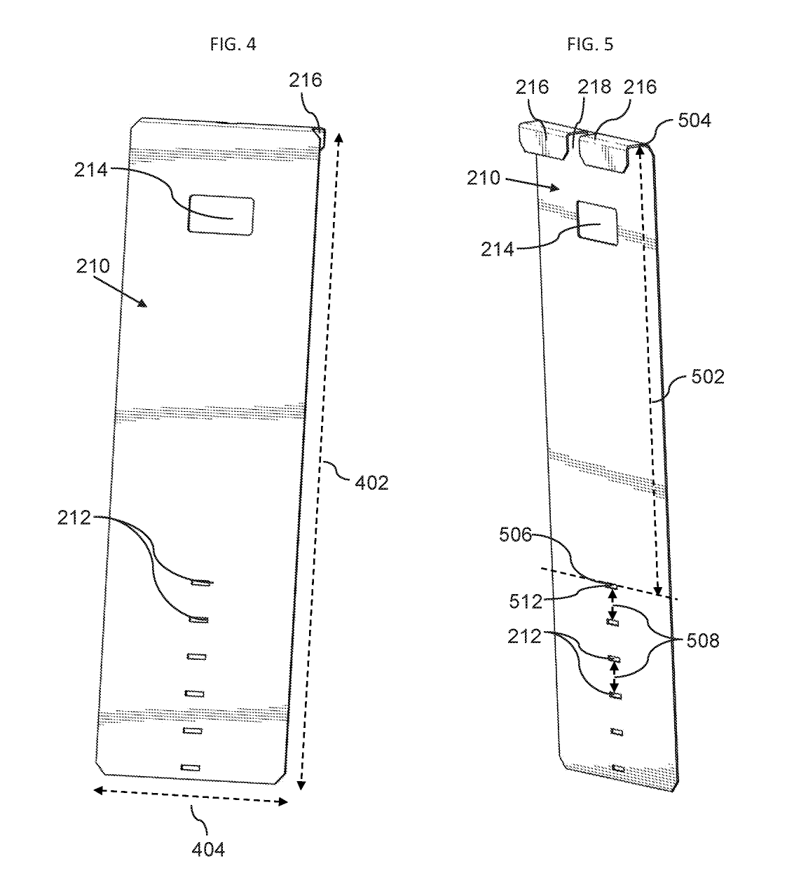

In a related embodiment, FIG. 4 shows a front perspective view of a hunting ladder guard plate 210.

In a related embodiment, FIG. 5 shows a rear perspective view of a hunting ladder guard plate 210. The plate hook 216 is in this embodiment configured as two separate plate hooks 216, separated by a plate hook aperture 218, which can provide space for an attachment on a rung, such as a ladder stabilizer 254, as shown on FIG. 2.

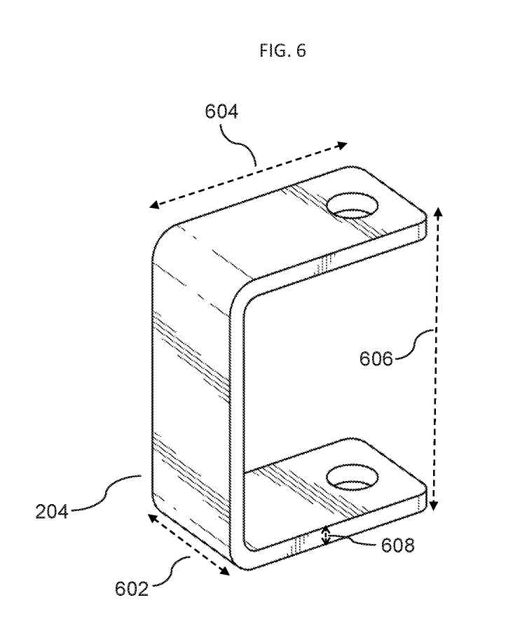

In a related embodiment, FIG. 6 shows a close-up perspective view of a bracket 204, which is substantially u-shaped, with parallel legs extending rearwards. Here, the u-shape of the bracket 204 is rectangular with rounded corners, but the substantially u-shaped configuration of the bracket 204 can alternatively be rectangular with sharp corners or be non-rectangular and fully rounded.

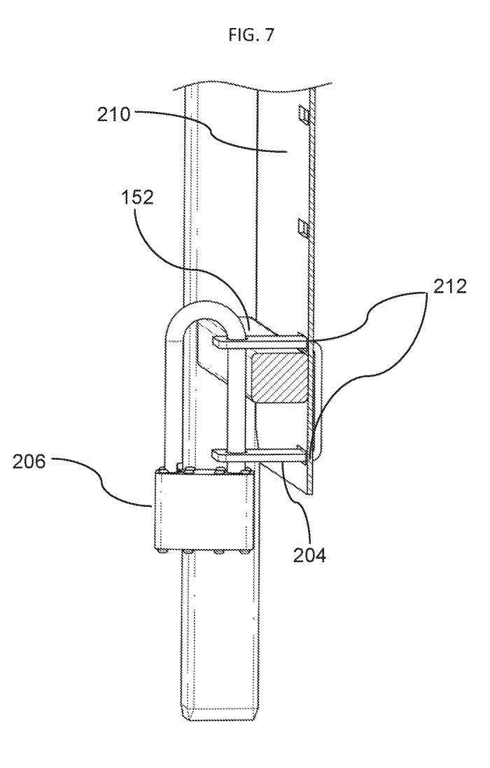

In a related embodiment, FIG. 7 shows a side, partially center-cut view of a section of a hunting ladder guard 100, showing a ladder guard plate 210, mounted to a rung 152, with a bracket 204 inserted through bracket apertures 212, and locked in place with a padlock 206.

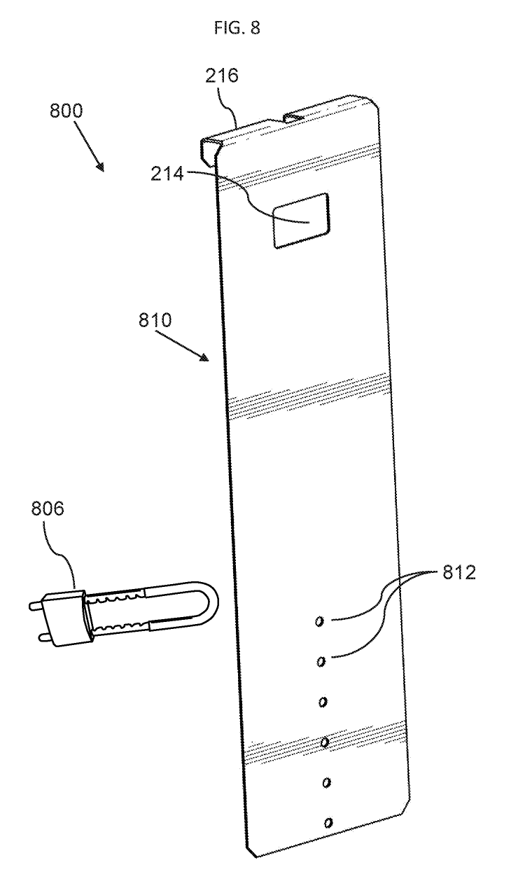

In a related embodiment, FIG. 8 shows a front perspective view of a hunting ladder guard 800, wherein the bracket apertures 812 are circular to be used with an adjustable shackle padlock 806, such that the upper end of the ladder guard plate 810 can be attached to an upper rung 152 of a ladder 150 using the plate hook 216, and a lower end of the ladder guard 800 can be securely attached to a lower rung 152 of the ladder 150, such that legs of an adjustable shackle padlock 806 are inserted through two consecutive bracket apertures 812, thereby locking the adjustable shackle padlock 806 in place around the lower rung, and thereby locking the lower end of the ladder guard 100 in place, attached to the lower rung 152.

In a related embodiment, the hunting ladder guard 800 can be used with a chain or cable inserted through bracket apertures 812 and secured in place around a rung 152 of a ladder 150 with a padlock, or the hunting ladder guard 800 can be secured with a cable lock, or similar type of locking device.

In a related embodiment, the bracket apertures 812 can be quadratic, rectangular, ellipsoid, or of other suitable shape, to facilitate use of a compatible locking device.

In various related embodiments, the hunting ladder guard 100 can be configured:
a) such that the ladder guard plate 210 is manufactured in a solid, rectangular shape, one-piece design;
b) to fit ladder rungs and tripod rungs in a plurality of column widths and rung height;
c) such that the plate hook 216 fits snugly over and is supported by the plurality of rectangular and circular rung designs of conventional ladders;
d) such that the ladder guard plate 210, when properly installed, blocks at least three consecutive ladder rungs 152.
e) to be sturdy, lightweight, weatherproof, and portable;
f) in a plurality of sizes to fit a plurality of ladder size, including non-standard ladder column widths; and/or
g) with rounded corners, and no sharp edges, for safety and esthetic appeal.

In a related embodiment, the ladder guard plate 210 can further include a plate cutout 214, which can be used as a carrying handle and for ease of positioning the device over objects protruding from the ladder 150.

In a related embodiment, the ladder guard plate 210 and the bracket 204 can be manufactured from metal, such as a high-strength aluminum alloy or stainless steel.

In a related embodiment, the ladder guard plate 210 and the bracket 204 can be painted with a camouflage colored powder coat finish.

In a related first example embodiment, as illustrated in FIG. 4, the ladder guard plate 210 can have a length 402 of substantially 34.5″ and a width 404 of substantially 11.75″, which will fit standard 14″ wide ladders 150.

In a related second example embodiment, the ladder guard plate 210 can have a length 402 of substantially 34.5″ and a width 404 of substantially 16″.

In a related third example embodiment, illustrated in FIG. 5, which is compatible with both the first and the second example embodiment, an upper side of the plate hook 216 is flush with a top edge of the ladder guard plate 210, and a horizontal level distance 502 from an upper inside 504 of the plate hook 216 to an upper edge 506 of the highest positioned bracket aperture 512 is substantially 23.75″. Additionally, as illustrated in FIG. 6, the bracket 204 can be substantially 1″ wide 602, by substantially 1.75″ deep 604, by substantially 2.125″ high 606, with a thickness 608 of substantially ⅛″. Correspondingly, each bracket aperture 212 can be substantially 1.25″ wide by substantially ¼″ high, with a 1.75″ distance 508 between each of a lower edge of a first bracket aperture 212 to the higher edge of a next-following second bracket aperture, whereby a bracket 204 can fit if the rung step height is not exactly 12″ and is less than 13″. The third example embodiment can fit a ladder 150 with a 12″ rung step height, providing 0.125″ wiggle room for the bracket.

In a related fourth example embodiment, as illustrated in FIG. 4, the ladder guard plate 210 can have a length 402 of substantially 45″ and a width 404 of substantially 11.75″ or 16″, which will fit standard 14″ wide ladders 150.

In a related embodiment, in a method of installing the hunting ladder guard 100, a user can be facing a ladder stand and hang the cover plate on a ladder rung, at approximately shoulder height.

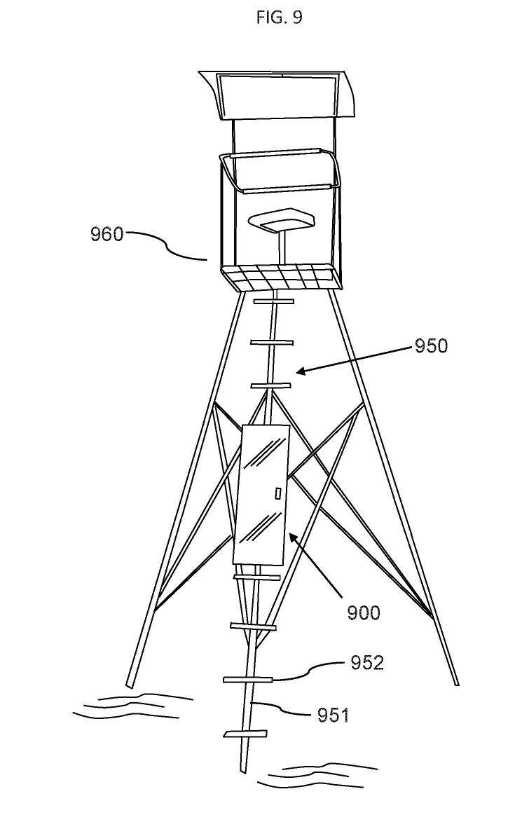

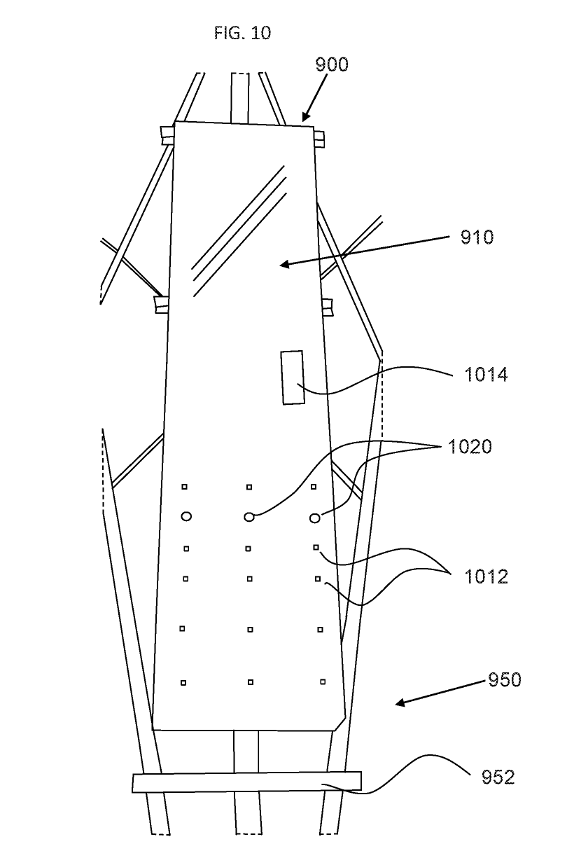

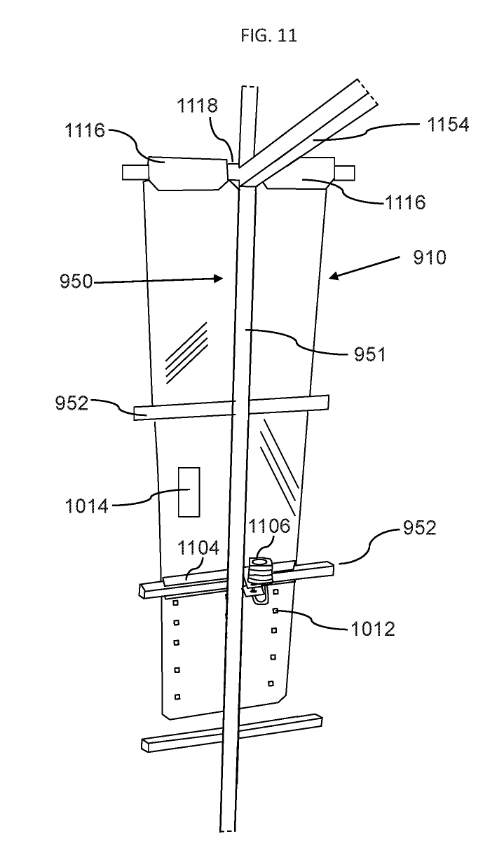

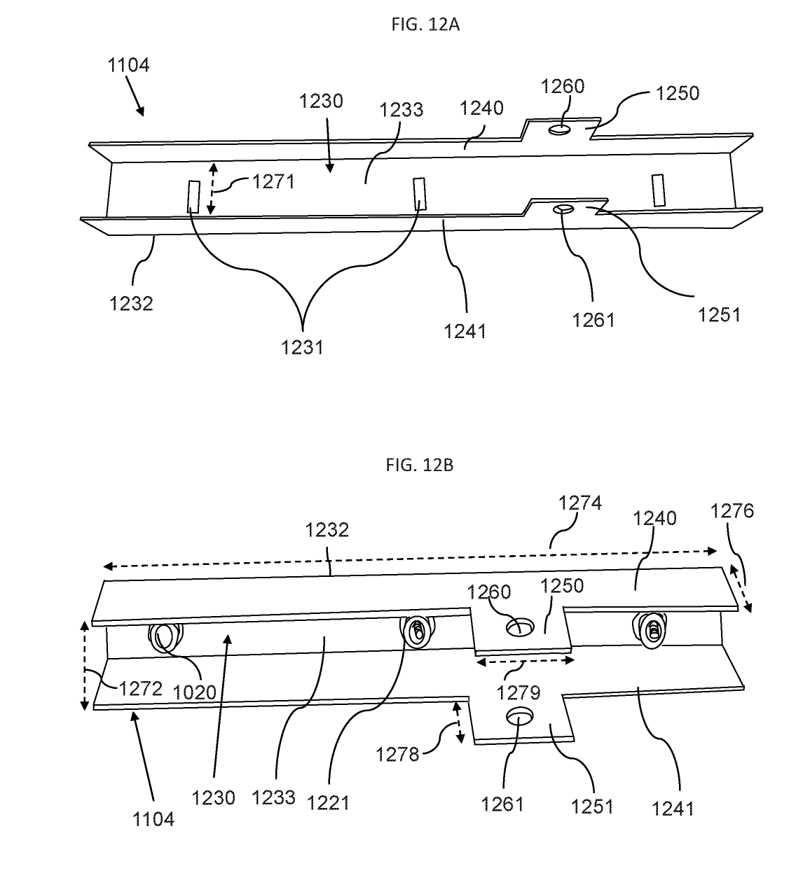

In a related embodiment, as illustrated in FIGS. 9-13B, a hunting ladder guard 900, can include:
a) a ladder guard plate 910, as shown in FIGS. 10 and 11, further including
   i. a plate hook 1116, which is connected to an upper end of the ladder guard plate 910; such that the plate hook 1116 is configured as an inward protruding hook that can attach on to a rung 952 of a hunting ladder 950;
   ii. a plurality of guard plate apertures 1012; and
b) a stabilizer bracket 1104, as shown in FIG. 11, and in FIGS. 12A-12B, including:
   i. a connector plate 1230, which can include
      1. a plurality of connector plate apertures 1231;
      2. an upper flange portion 1240; and
      3. a lower flange portion 1241;
         a. wherein the connector plate 1230 is connected to a lower end of the ladder guard plate 910 by bolts secured through both the guard plate apertures 1012 and the connector plate apertures 1231;
   ii. an upper flange extension 1250, which can be attached to the upper flange portion 1240;
   iii. and a lower flange extension 1251, which can be attached to the lower flange portion 1241;
   wherein the upper and lower flange extensions 1250 and 1251 respectively comprise an upper flange extension aperture 1260 and a lower flange extension aperture 1261;
such that an upper end of ladder guard plate 910 can be attached to an upper rung 952 of the ladder 950 using the plate hook 1116, and a lower end of the ladder guard 900 can be securely attached to a lower rung 952 of the ladder 950, such that the upper flange portion 1240 is above the lower rung 952 and the lower flange portion 1241 is below the lower rung 952, such that a padlock 1106 can be inserted through upper flange extension aperture 1260 and lower flange extension aperture 1261, thereby locking the stabilizer bracket 1104 in place around the lower rung 952, and thereby locking the lower end of the hunting ladder guard 900 in place, attached to the lower rung 952.

In a related embodiment, as illustrated in FIG. 9, a hunting ladder guard 900 can be installed on a tripod stand with integral hunting ladder 950, such that it prevents unauthorized use of the tripod stand hunting ladder 950, by covering a plurality of the rungs 952 of the tripod stand hunting ladder 950. FIG. 9 shows the hunting ladder guard 900 installed on tripod stand hunting ladder 950, where the hunting ladder 950 provides access to tripod stand hunting platform 960.

In a related embodiment, as illustrated in FIG. 10, a hunting ladder guard 900 can include a ladder guard plate 910 that can cover a plurality of rungs 952. The ladder guard plate 910 can include a plurality of guard plate apertures 1012, where the guard plate apertures 1012 can be arranged into a plurality of rows and columns. The guard plate apertures 1012 are configured to receive a plurality of bolts 1020, wherein the bolts 1020 can be threaded such that they can be used to secure a bracket as detailed below. The ladder guard plate 910 can also include a plate cutout 1014, which can be used as a carrying handle and for ease of positioning the device over objects protruding from the ladder 950.

In a related embodiment, as illustrated in FIG. 11, the ladder guard plate 910 can include a plate hook 1116 connected to the upper end of the ladder guard plate 910, wherein the plate hook 1116 is configured as an inward protruding hook that can attach onto an upper rung 952 of the hunting ladder 950. The plate hook 1116 depicted in FIG. 11 is configured as two separate plate hooks 1116 that are separated by a plate hook aperture 1118 such that a space is provided for an attachment on the rung 952 such as a ladder stabilizer 1154.

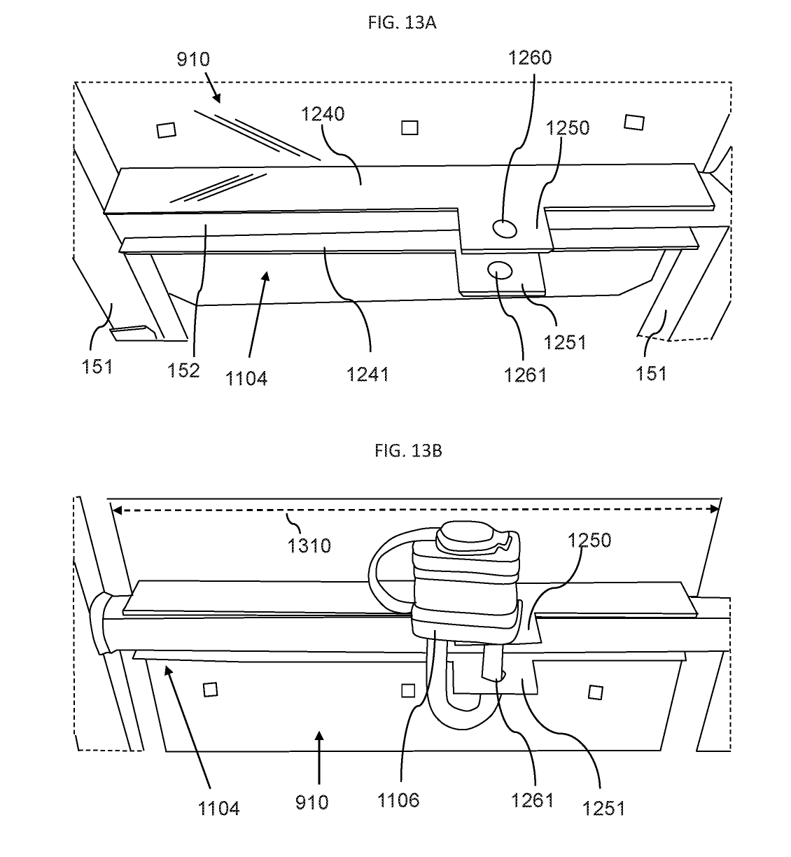

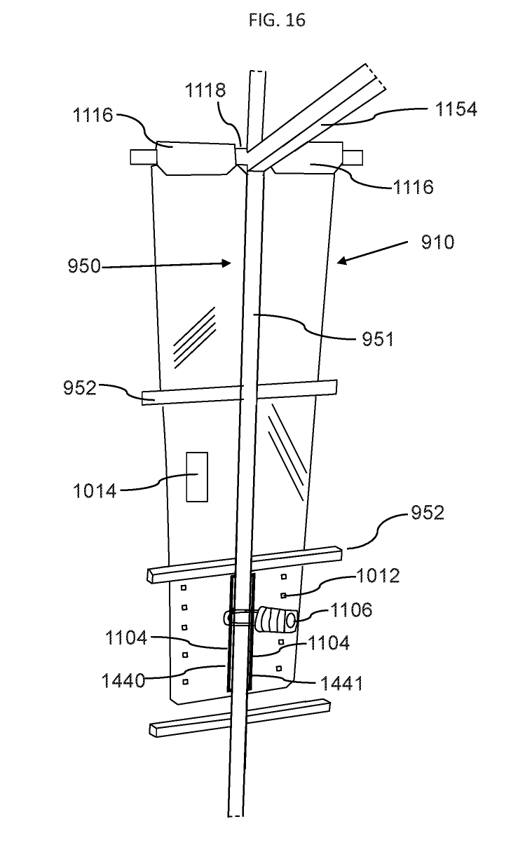

In related embodiments, the hunting ladder guard 900 is versatile and flexible, such that it can be used with a wide variety of different types and sizes of hunting ladders, including:
a) tripod stand hunting ladders 950, as shown in FIGS. 9-11, which include a central column 951, and rungs 952 mounted on the central column 951; and
b) conventional hunting ladders 150, as shown in FIGS. 13A, 13B, and 15, which includes rungs 152 mounted between side columns 151.

In a related embodiment, FIG. 12A shows an inner side perspective view of the stabilizer bracket 1104. The stabilizer bracket 1104 can include a connector plate 1230 having an inner side 1233 and an outer side 1232. The connector plate 1230 can include at least one connector plate aperture 1231.

In a related embodiment, each connector plate aperture 1231 can be elongated along a vertical direction 1271 of the stabilizer bracket 1104, in order to accommodate a range of positions of the bolt 1020 within the connector plate aperture 1231, whereby a position of the stabilizer bracket 1104 can be vertically adjusted, to allow a connection with a rung 952 of a ladder 950.

In a further related embodiment, the connector plate aperture 1231 can further be substantially rectangular, as shown in FIG. 12A, or can have another elongated shape, optionally with rounded ends.

In related embodiments, the plurality of spaced guard plate apertures 1012, in combination with the elongated connector plate apertures 1231, allow for versatility and flexibility in attaching the hunting ladder guard 900 to a wide variety of different types and sizes of hunting ladders, with different spacing between rungs, and even accommodating hunting ladders with uneven spacing between rungs.

As is further illustrated in FIG. 12A, showing an inner side perspective view of the stabilizer bracket 1104, the stabilizer bracket 1104 can include an upper flange portion 1240, which can also be referred to as the first flange portion 1240, and a lower flange portion 1241, which can also be referred to as the second flange portion 1241. The upper and lower flange portions 1240 and 1241 are configured to extend inwardly from the inner side 1233 of the connector plate 1230 toward a rung 952 of the hunting ladder 950 such that the upper flange portion 1240 is above a rung 952 and the lower flange portion 1241 is below a rung 952, as shown in FIG. 11.

As is further illustrated in FIG. 12A, upper and lower flange portions 1240 and 1241 include upper and lower flange extensions 1250 1251, respectively, extending inwardly from the connector plate 1230.

As is further illustrated in FIG. 12A, the upper and lower flange extensions 1250 1251 include upper flange extension aperture 1260 and lower flange extension aperture 1261, respectively. The upper and lower flange extension apertures 1260 and 1261 are configured to receive a portion of a padlock 1106, as shown in FIG. 11.

In a related embodiment, as illustrated in FIG. 12B, the outer side 1232 of the connector plate 1230 is secured to the lower end of the ladder guard plate 910 by the plurality of bolts 1020 and a plurality of nuts 1221. Each bolt 1020 is received in both a guard plate aperture 1012 of the ladder guard plate 910 and a connector plate aperture 1231. A nut 1221 is configured such that it can be tightened on to the bolt 1020 in a manner well known in the art, thereby firmly securing the stabilizer bracket 1104 to the ladder guard plate 910.

As is further illustrated in FIG. 12B, in certain embodiments the stabilizer bracket 1104 can be reversibly secured to the ladder guard plate 910 such that the upper flange portion 1240, also known as the first flange portion 1240, is situated below the lower flange portion 1241, also known as the second flange portion 1241.

As is further illustrated in FIG. 12B, the stabilizer bracket 1104 can have a width 1274, along a lateral direction 1274 of the stabilizer bracket 1104.

In a related embodiment, as illustrated in FIG. 13A, the upper and lower flange portions 1240 1241 extend inwardly from the ladder guard plate 910 toward a rung 952 of the hunting ladder 950 such that the upper flange portion 1240 is above a rung 952 and the lower flange portion 1241 is below a rung 952. This configuration allows the padlock 1106 to be received within the flange extension apertures 1260 and 1261, allowing the bracket 1104 to be locked to the rung 952, as shown in FIG. 13B, thereby locking the hunting ladder guard 900 to the hunting ladder 950.

As is further illustrated in FIG. 13B, the ladder guard plate can have a width 1310, where the ladder guard plate width 1310 and the stabilizer bracket width 1274 are substantially similar in order to increase the overall stability of the hunting ladder guard 900, or alternatively the stabilizer bracket width 1274 can be slightly less than the ladder guard plate width 1310, such as for example between a quarter inch and two inches narrower.

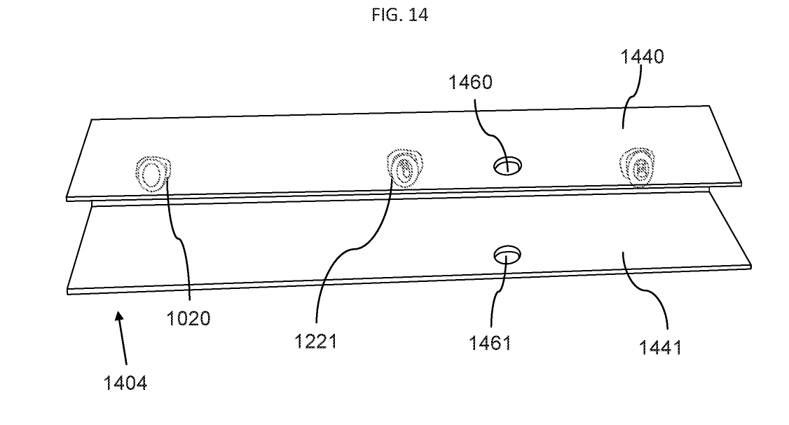

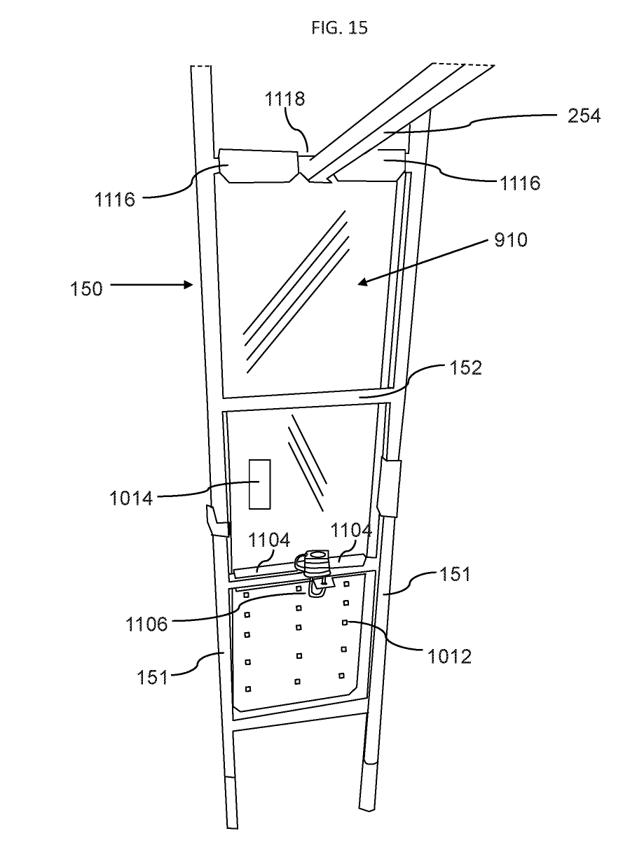

In a related embodiment, FIG. 14 shows an inner side perspective view of a stabilizer bracket 1404. In this embodiment, the stabilizer bracket 1404 can include an upper flange component 1440 and a lower flange component 1441. The upper flange component 1440 can include an upper flange aperture 1460 and the lower flange component 1441 can include a lower flange aperture 1461. The upper and lower flange components 1440 1441 extend behind the rung 952 of the ladder 950, such that the padlock 1106 can be locked through the upper and lower flange apertures 1460 and 1461, allowing the bracket 1404 to be locked to the rung 952.

In a related embodiment,
a) the upper flange component 1440 can further comprise the upper flange portion 1240 and the upper flange extension 1250, wherein the upper flange extension 1250 comprises:
   i) the upper flange aperture 1460; and
b) the lower flange component 1441 can further comprise the lower flange portion 1241 and the lower flange extension 1251, wherein the lower flange extension 1251 comprises:
   i) the lower flange aperture 1461; and
such that the first and second flange extensions 1250 1251 are configured to extend behind the second rung.

In related embodiments, as illustrated in FIG. 16, the stabilizer bracket 1104 can be connected vertically to the ladder guard plate 910, such that the stabilizer bracket 1104 can attach to a vertical column of a hunting ladder 950, which can include a column 951 of a tripod stand hunting ladders 950, or a vertical column of a climbing stick, or other ladder structures with a vertical column, such that the first flange component 1440 can be disposed on a first side of the column, and the second flange component 1441 can be disposed on a second side of the column.

In further related embodiments, two stabilizer brackets 1104 can be connected vertically to the ladder guard plate 910, such that the stabilizer brackets 1104 can attach to two vertical columns 151 of a conventional hunting ladder 150.

Thus, in the many possible embodiments, the stabilizer bracket 1104 can be connected either horizontally or vertically to the ladder guard plate 910, such that the stabilizer bracket 1104 can attach to a column, which can be:
a) a horizontal column, such as a rung 152 952; or
b) a vertical column 151 951 of a hunting ladder 150 950.

In a related embodiment, the hunting ladder guard 900 can be used with a chain or cable inserted through flange extension apertures 1260 and 1261 and thereby secured in place around a lower rung 952 of a ladder 950, or the hunting ladder guard 900 can be secured with a cable lock, or similar type of locking device.

In a related embodiment, the front apertures 1231 and guard plate apertures 1012 can be quadratic, rectangular, ellipsoid, or of other suitable shape, to facilitate use of the plurality of bolts 1020.

In an example embodiment, the stabilizer bracket 1104, can be configured with:
a) a height 1272 of 2 inches;
b) a main depth 1276 of 1.5 inches;
c) an extension depth 1278 of 1 inch;
d) an extension width 1279 of 1.5 inches.

In an example embodiment, the elongated connector plate apertures 1231, can be configured with:
a) a length of 1 inch; and
b) a width of 0.5 inch.

In various related embodiments, the hunting ladder guard 900 can be configured:
a) such that the ladder guard plate 910 is manufactured in a solid, rectangular shape, one-piece design;
b) to fit ladder rungs and tripod hunting stand ladder rungs in a plurality of column widths and rung height;
c) such that the plate hook 1116 fits snugly over and is supported by the plurality of rectangular and circular rung designs of conventional ladders;
d) such that the ladder guard plate 910, when properly installed, blocks at least three consecutive ladder rungs 952.
e) to be sturdy, lightweight, weatherproof, and portable;
f) in a plurality of sizes to fit a plurality of ladder sizes, including non-standard ladder column widths and rung heights; and/or
g) with rounded corners, and no sharp edges, for safety and esthetic appeal.

In a related embodiment, the ladder guard plate 910 and the stabilizer bracket 1104 can be manufactured from metal, such as a high-strength aluminum alloy or stainless steel.

In a related embodiment, the ladder guard plate 910 and the stabilizer bracket 1104 can be painted with a camouflage colored powder coat finish.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention

What is claimed is:

1. A ladder guard to prevent access to a ladder, comprising:
a) a ladder guard plate, further comprising:
i) a plate hook, which is connected to an upper end of the ladder guard plate, such that the plate hook is configured as an inward protruding hook; and
ii) at least one guard plate aperture;
b) at least one bolt;
c) at least one nut; and
d) a stabilizer bracket, further comprising:
i) a connector plate, further comprising:
at least one connector plate aperture;
wherein the connector plate is connected to a lower end of the ladder guard plate with the at least one bolt, which is bolted in place through the at least one guard plate aperture and the at least one connector plate aperture, such that the at least one bolt is fastened with the at least one nut;
ii) an upper flange portion, which is connected to the connector plate;
iii) a lower flange portion, which is connected to the connector plate;
iv) an upper flange extension, further comprising:
an upper flange extension aperture;
wherein the upper flange extension is connected to the upper flange portion; and
v) a lower flange extension, further comprising:
a lower flange extension aperture;
wherein the lower flange extension is connected to the lower flange portion;
wherein the plate hook is configured to attach the ladder guard plate to an upper rung of the ladder; and
wherein the stabilizer bracket is configured to attach the ladder guard plate to a lower rung of the ladder, such that the upper flange portion is above the lower rung and the lower flange portion is below the lower rung;
such that the upper and lower flange extensions extend behind the lower rung;
such that the stabilizer bracket is configured to allow a padlock to be inserted through the upper flange extension aperture and the lower flange extension aperture, thereby locking the stabilizer bracket in place around the lower rung, and thereby locking the lower end of the ladder guard in place, attached to the lower rung.

2. The ladder guard of claim 1, wherein the at least one connector plate aperture is elongated along a vertical direction of the stabilizer bracket, such that the at least one connector plate aperture is configured to accommodate a range of positions of the at least one bolt when inserted through the at least one connector plate aperture.

3. The ladder guard of claim 1, wherein the ladder guard plate further includes at least one plate cutout, which is used as a carrying handle and for ease of positioning the ladder guard over objects protruding from the ladder.

4. The ladder guard of claim 1, wherein the at least one guard plate aperture comprises a plurality of guard plate apertures.

5. The ladder guard of claim 4, wherein the plurality of guard plate apertures are arranged in a plurality of rows and a plurality of columns.

6. The ladder guard of claim 1, wherein the at least one connector plate aperture comprises a plurality of connector plate apertures.

7. The ladder guard of claim 1, wherein the plate hook is configured as two separate plate hooks, which are separated by a plate hook aperture, such that the plate hook aperture is configured to provide space for an attachment on the upper rung.

8. A ladder guard, comprising:
a) a ladder guard plate, further comprising a plate hook; and
b) a stabilizer bracket, further comprising:
i) a first flange component; and
ii) a second flange component;
wherein the stabilizer bracket is connected to the ladder guard plate;
wherein the plate hook is configured to attach the ladder guard plate to a rung of the ladder; and
wherein the stabilizer bracket is configured to attach the ladder guard plate to a column of the ladder, such that the first flange component is disposed on a first side of the column and the second flange component is disposed on a second side of the column.

9. The ladder guard of claim 8, wherein
a) the first flange component further comprises a first flange component aperture; and
b) the second flange component further comprises a second flange component aperture;
such that the stabilizer bracket is configured to allow a padlock to be inserted through the first flange extension aperture and the second flange extension aperture, thereby locking the stabilizer bracket in place around the column, and thereby locking the second end of the ladder guard in place, attached to the column.

10. The ladder guard of claim 8, wherein the plate hook is connected to an upper end of the ladder guard plate and the stabilizer bracket is connected to a lower end of the ladder guard plate.

11. The ladder guard of claim 8, wherein the ladder guard plate further comprises at least one guard plate aperture, and wherein the stabilizer bracket further comprises a connector plate, and wherein the connector plate further comprises at least one connector plate aperture.

12. The ladder guard of claim 11, wherein the at least one connector plate aperture is elongated along a vertical direction of the stabilizer bracket, such that the connector plate aperture is configured to accommodate a range of positions of a bolt inserted through the connector plate aperture.

13. The ladder guard of claim 11, further comprising at least one bolt, wherein the connector plate is connected to the ladder guard plate with the at least one bolt, which is bolted in place through the at least one guard plate aperture and the at least one connector plate aperture.

14. The ladder guard of claim 11, wherein the at least one guard plate aperture comprises a plurality of plate apertures, and the at least one connector plate aperture comprises a plurality of connector plate apertures.

15. The ladder guard of claim 14, wherein the plurality of guard plate apertures are arranged in a plurality of rows and a plurality of columns.

16. The ladder guard of claim 8, wherein
a) the first flange component further comprises a first flange portion and a first flange extension, wherein the first flange extension comprises:
the first flange component aperture; and
b) the second flange component further comprises a second flange portion and a second flange extension, wherein the second flange extension comprises:
the second flange component aperture;
such that the first and second flange extensions are configured to extend behind the column.

17. The ladder guard of claim 8, wherein the plate hook is connected to a first end of the ladder guard plate, such that the plate hook is configured as an inward protruding hook that attaches to the rung of the ladder.

18. The ladder guard of claim 8, wherein the plate hook comprises two separate plate hooks, which are separated by a plate hook aperture, such that the plate hook aperture is configured to provide space for an attachment on the upper rung.

19. The ladder guard of claim 8, wherein the stabilizer bracket is horizontally connected to the ladder guard plate.

20. The ladder guard of claim 8, wherein the stabilizer bracket is vertically connected to the ladder guard plate.
